(19) United States
(12) Patent Application Publication
(10) Pub. No.: US 2026/0257227 A1
(43) Pub. Date: Sep. 3, 2026

(54) PORTABLE NUCLEIC ACID DETECTION DEVICE, SYSTEM AND METHOD

(71) Applicant: HANGZHOU EZDX TECHNOLOGY CO., LTD, Hangzhou (CN)

(72) Inventors: Jinzhao SONG, Hangzhou (CN); Feibiao PANG, Hangzhou (CN); Fengyi DAI, Hangzhou (CN); Kaizheng WANG, Hangzhou (CN); Yinyue NI, Hangzhou (CN); Tianjiao JIAO, Hangzhou (CN); Liyi ZHANG, Hangzhou (CN)

(73) Assignee: HANGZHOU EZDX TECHNOLOGY CO., LTD, Hangzhou (CN)

(21) Appl. No.: 18/995,895

(22) PCT Filed: Jul. 27, 2023
(86) PCT No.: PCT/CN2023/109464

§ 371 Date: Jan. 17, 2025

(30) Foreign Application Priority Data
Aug. 16, 2022 (CN) 202210983377.8
Aug. 16, 2022 (CN) 202222162713.0

(51) Int. Cl. B01L 7/00

(52) U.S. Cl. CPC B01L 7/52; B01L 2200/147; B01L 2300/043; B01L 2300/1805

(57) ABSTRACT

Provided are a portable nucleic acid detection device, system and method. The device includes a main body with a mounting cavity for mounting a bearing module configured to accommodate a reaction tube. The reaction tube is configured to accommodate a to-be-detected sample. The bearing module is connected to a heating module configured to regulate temperatures of the bearing module and the reaction tube. The main body is connected to a light-emitting module arranged at a bottom of the bearing module. The bearing module is provided with a light-transmission hole facing the light-emitting module, so that emitted light of the light-emitting module is irradiated on the reaction tube by means of the light-transmission hole. The main body is further provided with an observation window. A first side of the bearing module is provided with a first observation hole configured for observation of the reaction tube.

### CROSS REFERENCE TO THE RELATED APPLICATIONS

This application is the national phase entry of International Application No. PCT/CN2023/109464, filed on Jul. 27, 2023, which is based upon and claims priority to Chinese Patent Application No. 202210983377.8, filed on Aug. 16, 2022, and Chinese Patent Application No. 202222162713.0, filed on Aug. 16, 2022, the entire contents of which are incorporated herein by reference.

### TECHNICAL FIELD

The present disclosure relates to the field of nucleic acid detection, and in particular to a portable nucleic acid detection device, system and method.

### BACKGROUND

How to quickly and efficiently test/detect viruses, so as to discover and prevent virus epidemics in a timely manner, is of great significance for epidemic prevention. However, virus testing/detection instruments in the related art are often bulky and inconvenient to carry and use. Moreover, virus detection requires centralized sampling, centralized processing, etc., resulting in a long time interval from sampling to obtaining detection results. In addition, testing needs to be carried out in certified laboratories and also needs corresponding large instruments and well-trained operators, and cumbersome steps greatly increase the risk of cross infection.

### SUMMARY

The present disclosure provides a portable nucleic acid detection device, system and method to at least solve the above technical problems existing in the related art.

According to a first aspect of the present disclosure, a portable nucleic acid detection device is provided, including a main body. The main body is provided with a mounting cavity for mounting a bearing module, the bearing module is configured to accommodate a reaction tube, and the reaction tube is configured to accommodate a to-be-detected sample. The bearing module is connected to a heating module, and the heating module is configured to regulate a temperature of the bearing module, so as to regulate a temperature of the reaction tube. The main body is connected to a light-emitting module, the light-emitting module is arranged at a bottom of the bearing module, and the bearing module is provided with a light-transmission hole facing the light-emitting module, such that light emitted from the light-emitting module irradiates the reaction tube via the light-transmission hole. The main body is further provided with an observation window, a first side of the bearing module is provided with a first observation hole, and the first observation hole is configured to observe the reaction tube; when the bearing module is mounted in the mounting cavity, the observation window is configured to observe the reaction tube via the first observation hole.

In one implementation, the bearing module may be provided with a plurality of grooves, and the groove is configured to accommodate the reaction tube. A quantity of the light-transmission hole may be consistent with a quantity of the groove, the light-transmission hole may be arranged at a bottom of the groove, and the light-emitting module may be securely connected to the bottom of the bearing module, such that the light emitted from the light-emitting module irradiates the reaction tube via the light-transmission hole. The bearing module may further include a mounting plate, and the mounting plate may be configured to cooperate with the main body to fix the bearing module in the mounting cavity.

In one implementation, the heating module may be connected to a second side of the bearing module, the second side may be different from the first side. The heating module may include a heating element, a temperature sensor, and an overheat protection module; the temperature sensor may be arranged between the heating element and the bearing module, the heating module may be configured to regulate the temperature of the bearing module, and the temperature sensor may be configured to detect the temperature of the bearing module. The temperature sensor may be connected to the overheat protection module, and the overheat protection module may be connected to the heating element; when a temperature detected by the temperature sensor is higher than a specified temperature, the overheat protection module may be configured to allow the heating element to stop heating.

In one implementation, the temperature sensor may include at least one of a thermistor, a platinum resistor, or a thermocouple; and the heating element may include at least one of a ceramic heating element, an electric heating film, an electric heating wire, a power resistor, or a semiconductor heating element.

In one implementation, the main body may include a cover and a shell, the cover may be rotatably connected to the shell, and the shell may be configured to abut against the bearing module; the cover may include a pressure plate, and the pressure plate may be elastically connected to the cover by an elastic member; when the cover covers the shell, the pressure plate may be configured to press the reaction tube in the bearing module.

In one implementation, the cover may be provided with a magnetic switch, and the magnetic switch may be configured to cooperate with the shell to open or close the cover.

In one implementation, the portable nucleic acid detection device may be provided with a controlling module, and the controlling module may be connected to the heating module for controlling the heating module to regulate the temperature of the bearing module. The controlling module may be further connected to the light-emitting module for controlling the light-emitting module to emit the light to irradiate the reaction tube. The controlling module may be connected to a mobile device for receiving control instructions from the mobile device, so as to control the heating module to regulate the temperature of the bearing module through the control instructions, or to control the light-emitting module to emit the light through the control instructions.

In one implementation, the portable nucleic acid detection device may further include a darkroom shell, and the darkroom shell may be configured to mount a mobile device or a camera. The darkroom shell may be provided with a second observation hole, and the second observation hole may be configured to cooperate with the mobile device or the camera to observe the reaction tube.

In one implementation, the darkroom shell may be provided with a fixing mechanism, and the fixing mechanism is configured to fix the mobile device, such that the mobile device observes the reaction tube via the second observation hole.

In one implementation, a filter may be mounted on an observation port of the observation window.

According to a second aspect of the present disclosure, a portable nucleic acid detection system is provided, including: a mobile device and the above-mentioned portable nucleic acid detection device. The mobile device is connected to the portable nucleic acid detection device by communication, and cooperates with the portable nucleic acid detection device for a detection operation.

According to a third aspect of the present disclosure, a nucleic acid detection method is provided, including: placing a reaction tube containing a to-be-detected sample into a bearing module; mounting the bearing module into a mounting cavity; according to detection instructions from a mobile device, controlling a heating module to heat the bearing module to a specified temperature, such that the reaction tube is at the specified temperature; according to the detection instructions from the mobile device, controlling a light-emitting module to emit light, such that the emitted light irradiates the reaction tube via a light-transmission hole; and observing the reaction tube via an observation window on a main body and a first observation hole on the bearing module, and determining a detection result based on a fluorescence reaction in the reaction tube under irradiation of the emitted light.

According to the portable nucleic acid detection device and method of the present disclosure, the reaction tube containing the to-be-detected sample is placed in the bearing module; the bearing module is mounted in the mounting cavity; according to the detection instructions from the mobile device, the heating module is controlled to heat the bearing module to a specified temperature, the light-emitting module is controlled to emit light, and the emitted light irradiates the reaction tube via the light-transmission hole; the to-be-detected sample fully reacts in the reaction tube by heating the reaction tube, the light emitted from the light-emitting module irradiates the reaction tube via the light-transmission hole, and fluorescence reaction in the reaction tube under the irradiation of the emitted light is observed to determine a detection result. Therefore, the steps are simple, the process is convenient, and the detection result of the to-be-detected sample can be quickly obtained. In addition, the device has a simple and light structure, and can be conveniently carried and used at home.

It should be understood that the content described in this section is not intended to identify critical or important features of the embodiments of the present disclosure, and is not used to limit the scope of the present disclosure either. The other features of the present disclosure will be easily understood through the specification below.

### BRIEF DESCRIPTION OF THE DRAWINGS

By reading the following detailed description with reference to the accompanying drawings, the above and other objectives, features and advantages of the exemplary embodiments of the present disclosure will become easier to understand. In the accompanying drawings, several embodiments of the present disclosure are shown by way of example rather than limitation. The same or corresponding reference numerals denote the same or corresponding parts.

FIG. 1 illustrates a first structural diagram of a portable nucleic acid detection device according to an embodiment of the present disclosure;

FIG. 2 illustrates a second structural diagram of the portable nucleic acid detection device according to an embodiment of the present disclosure;

FIG. 3 illustrates a third structural diagram of the portable nucleic acid detection device according to an embodiment of the present disclosure;

FIG. 4 illustrates a fourth structural diagram of the portable nucleic acid detection device according to an embodiment of the present disclosure;

FIG. 5 illustrates a fifth structural diagram of the portable nucleic acid detection device according to an embodiment of the present disclosure;

FIG. 6 illustrates a sixth structural diagram of the portable nucleic acid detection device according to an embodiment of the present disclosure;

FIG. 7 illustrates a seventh structural diagram of the portable nucleic acid detection device according to an embodiment of the present disclosure; and

FIG. 8 illustrates an eighth structural diagram of the portable nucleic acid detection device according to an embodiment of the present disclosure.

### DETAILED DESCRIPTION OF THE EMBODIMENTS

1, Main body; 11, Bearing module; 111, Light-transmission hole; 112, First observation hole; 113, Groove; 114, Mounting plate; 115, Mounting hole; 12, Heating module; 121, Heating element; 122, Temperature sensor; 123, Overheat protection module; 13, Light-emitting module; 14, Observation window; 15, Cover; 151, Pressure plate; 152, Magnetic switch; 153, Cover mounting plate; 154, Elastic member; 155, Pressure plate groove; 16, Shell; 161, Mounting plate mounting column; 162, Button mounting column; 17, Controlling module; 18, Power module; 2, Reaction tube; 21, To-be-detected sample; 3, Darkroom shell; 31, Second observation hole; 32, Fixing mechanism; 321, Camera mounting hole; 322, Slide rail; 323, Fixing screw; 324, slider; 325, Rubber pad; 4, Bottom plate.

### DETAILED DESCRIPTION OF THE EMBODIMENTS

In order to make the objectives, features, and advantages of the present disclosure more apparent and easier to understand, the technical solutions in the embodiments of the present disclosure will be clearly and completely described below with reference to the accompanying drawings therein. Apparently, the described embodiments are merely a part rather than all of the embodiments of the present disclosure. All other embodiments obtained by those skilled in the art based on the embodiments of the present disclosure without any creative efforts shall fall within the protection scope of the present disclosure.

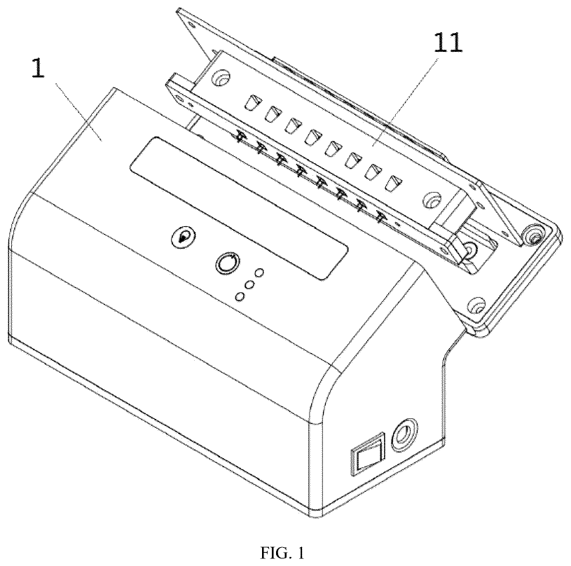

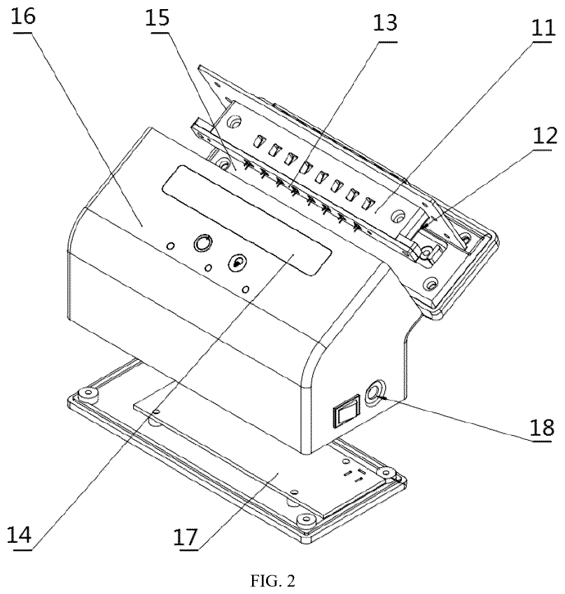

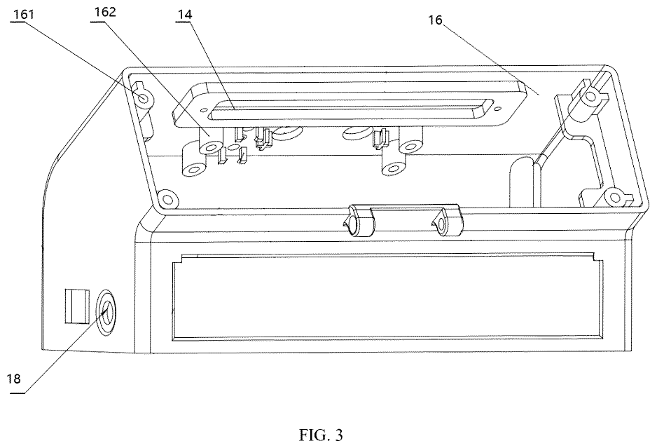

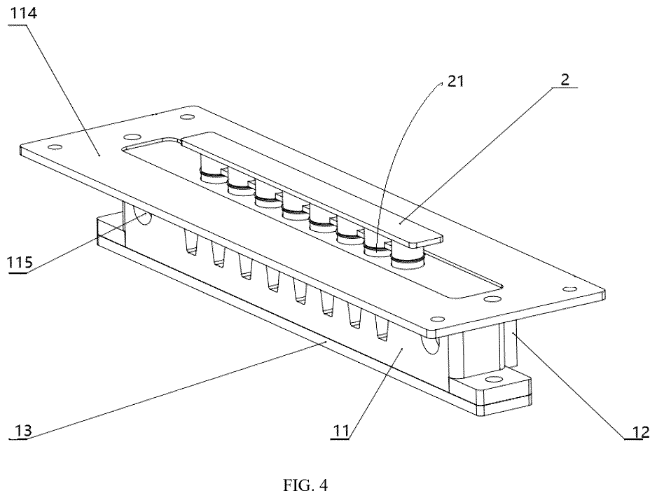

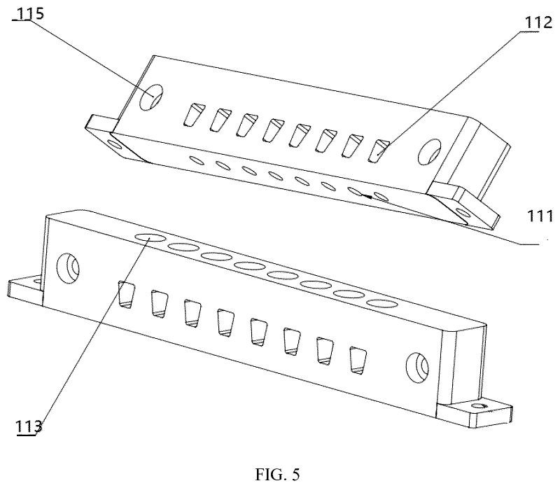

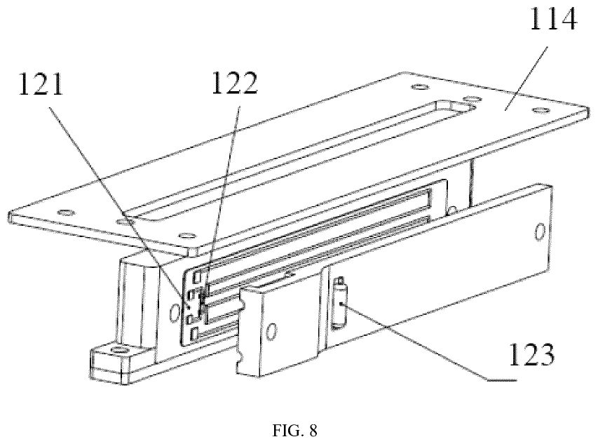

FIG. 1 illustrates a first structural diagram of a portable nucleic acid detection device according to an embodiment of the present disclosure; FIG. 2 illustrates a second structural diagram of the portable nucleic acid detection device according to an embodiment of the present disclosure; FIG. 3 illustrates a third structural diagram of the portable nucleic acid detection device according to an embodiment of the present disclosure; FIG. 4 illustrates a fourth structural diagram of the portable nucleic acid detection device according to an embodiment of the present disclosure; FIG. 5 illustrates a fifth structural diagram of the portable nucleic acid detection device according to an embodiment of the present disclosure; and FIG. 8 illustrates an eighth structural diagram of the portable nucleic acid detection device according to an embodiment of the present disclosure. Refer to FIG. 1 to FIG. 5 and FIG. 8.

According to a first aspect of the present disclosure, a portable nucleic acid detection device is provided. The device includes a main body 1; the main body 1 is provided with a mounting cavity for mounting a bearing module 11, the bearing module 11 is configured to accommodate a reaction tube 2, and the reaction tube 2 is configured to accommodate a to-be-detected sample 21. The bearing module 11 is connected to a heating module 12, and the heating module 12 is configured to regulate a temperature of the bearing module 11, so as to regulate a temperature of the reaction tube 2. The main body 1 is connected to a light-emitting module 13, the light-emitting module 13 is arranged at a bottom of the bearing module 11, and the bearing module 11 is provided with a light-transmission hole 111 facing the light-emitting module 13, such that light emitted from the light-emitting module 13 irradiates the reaction tube 2 via the light-transmission hole 111. The main body 1 is further provided with an observation window 14, a first side of the bearing module 11 is provided with a first observation hole 112, and the first observation hole 112 is configured to observe the reaction tube 2; when the bearing module 11 is mounted in the mounting cavity, the observation window 14 is configured to observe the reaction tube 2 via the first observation hole 112.

According to the portable nucleic acid detection device and a corresponding nucleic acid detection method of the present disclosure, the reaction tube 2 containing the to-be-detected sample 21 is placed in the bearing module 11; the bearing module 11 is mounted in the mounting cavity; according to detection instructions from a mobile device, the heating module 12 is controlled to heat the bearing module 11 to a specified temperature, the light-emitting module 13 is controlled to emit light, and the emitted light irradiates the reaction tube 2 via the light-transmission hole 111; the to-be-detected sample 21 fully reacts in the reaction tube 2 by heating the reaction tube 2, the light emitted from the light-emitting module 13 irradiates the reaction tube 2 via the light-transmission hole 111, and a fluorescence reaction in the reaction tube 2 under irradiation of the emitted light is observed to determine a detection result. In the present application, he steps are simple, the process is convenient, and the detection result of the to-be-detected sample 21 can be quickly obtained. In addition, the device has a simple and light structure, and can be conveniently carried and used at home.

Moreover, the light-emitting module 13 can be omitted, and the reaction tube 2 can be directly observed through the observation window 14. Correspondingly, the reaction tube 2 can be used for chemiluminescence, colorimetric reaction, and the like. Thus, the flexible application of the portable nucleic acid detection device is improved, and the device can adapt to various detection modes and better meet household or portable needs. Alternatively, the light-emitting module 13 and the colorimetric reaction in the reaction tube 2 can also used to implement nucleic acid detection.

In embodiments of the present disclosure, the main body 1 refers to a main component of the device. Specifically, the main body 1 includes a shell 16 and a cover 15, the shell 16 is configured to mount the bearing module 11, and the cover 15 is configured to cover the shell 16. When the cover 15 covers the shell 16, the mounting cavity for mounting the bearing module 11 is formed. Several/a plurality of grooves 113 are formed in the bearing module 11, and the groove 113 is configured to accommodate the reaction tube 2, specifically to insert the reaction tube 2. The reaction tube 2 is configured to accommodate the to-be-detected sample 21. Specifically, the reaction tube 2 further includes a testing agent for detecting the to-be-detected sample 21. By mixing the testing agent with the to-be-detected sample 21, a detection reaction is carried out in the reaction tube 2 to detect the to-be-detected sample 21. The detection process requires heating the reaction tube 2. The bearing module 11 is connected to the heating module 12, and the heating module 12 is configured to regulate the temperature of the bearing module 11, so as to regulate the temperature of the reaction tube 2. The heating module 12 is connected to a second side of the bearing module 11, and the second side is different from the first side. Specifically, the second side is opposite to the first side in direction, as shown in FIG. 8. The heating module 12 includes a heating element 121, a temperature sensor 122, and an overheat protection module 123; the temperature sensor 122 is arranged between the heating element 121 and the bearing module 11, the heating module 12 is configured to regulate the temperature of the bearing module 11, and the temperature sensor 122 is configured to detect the temperature of the bearing module 11. The temperature sensor 122 is connected to the overheat protection module 123, and the overheat protection module 123 is connected to the heating element 121; when a temperature detected by the temperature sensor 122 is higher than a specified temperature, the overheat protection module 123 is configured to allow the heating element 121 to stop heating. The specified temperature may be preset by the staff based on properties of the to-be-detected sample 21. Specifically, the bearing module 11 and the heating module 12 may be provided with mounting holes 115, and the mounting holes 115 are disposed at two ends to match fasteners for fixing the heating module 12 to the bearing module 11. The temperature sensor 122 includes at least one of a thermistor, a platinum resistor, or a thermocouple; and the heating element 121 includes at least one of a ceramic heating element, an electric heating film, an electric heating wire, a power resistor, or a semiconductor heating element. The portable nucleic acid detection device is provided with a controlling module 17, and the controlling module 17 is connected to the heating module 12 for controlling the heating module 12 to regulate the temperature of the bearing module 11. The controlling module 17 is further connected to the light-emitting module 13 for controlling the light-emitting module 13 to emit the light to irradiate the reaction tube 2. Specifically, the controlling module 17 may include a voltage reduction module for converting 24V to 5V, which is the operating voltage of a microcontroller; a low-dropout regulator module for converting 5V to 3.3V; a heating drive circuit for controlling heating by using PWM; and a temperature collection circuit, a crystal oscillator circuit, and a restart circuit.

The main body 1 is connected to the light-emitting module 13, the light-emitting module 13 is arranged at the bottom of the bearing module 11, and the bearing module 11 is provided with the light-transmission hole 111 facing the light-emitting module 13, such that the light emitted from the light-emitting module 13 irradiates the reaction tube 2 via the light-transmission hole 111. Specifically, a quantity of the light-transmission hole 111 is consistent with a quantity of the groove 113, the light-transmission hole 111 is arranged at a bottom of the groove 113, and the light-emitting module 13 is securely connected to the bottom of the bearing module 11, such that the light emitted from the light-emitting module 13 irradiates the reaction tube 2 via the light-transmission hole 111. Specifically, the emitted light is perpendicular to the reaction tube 2, and the emitted light is perpendicular to the first observation hole 112, in this way, the emitted light is not directly incident in the direction of the first observation hole 112, so the impact on the observation of the emitted light via the observation hole is minimized. The main body 1 is further provided with the observation window 14, the first side of the bearing module 11 is provided with the first observation hole 112, and the first observation hole 112 is configured to observe the reaction tube 2. The first observation hole 112 is a trapezoidal hole, and a cross-section of the first observation hole 112 is exactly tangent to a bearing cavity of the conical reaction tube 2, such that all reaction liquid can exactly be observed via the first observation hole 112. When the bearing module 11 is mounted in the mounting cavity, the observation window 14 is configured to observe the reaction tube 2 via the first observation hole 112. Specifically, a mounting plate 114 is connected above the bearing module 11, and the mounting plate 114 is configured to cooperate with the main body 1 to fix the bearing module 11 in the mounting cavity. Specifically, a mounting plate mounting column 161 is formed inside the shell 16, and the mounting plate mounting column 161 is configured to cooperate with the mounting plate 114 to fix the bearing module 11, such that the first observation hole 112 on the bearing module 11 matches the position of the observation window 14 on the shell 16. For the convenience of observation, a filter may be mounted on an observation port of the observation window 14. Furthermore, the observation window 14 may include an observation port, a filter, and a light blocking plate. The filter may be a low-cost orange acrylic plate to reduce instrument costs. The purpose of the filter is to filter out excitation light signals in the first observation hole 112 and allow fluorescence signals to pass through. The purpose of the light blocking plate is to prevent light signals from other places except the first observation hole 112 from affecting observation results. There are two ways to obtain a detection result: in the first mode, the tester directly observes via the observation port of the observation window whether there is a fluorescence signal in the reaction tube 2, to qualitatively obtain the detection result; in the second mode, software developed at a mobile terminal and a mobile camera are used to capture and store an image, which is then processed to obtain the detection result. The main body 1 is further provided with a power module 18, and the power module 18 may be an internal power source and/or an external power source. When the power module 18 includes the external power source, a power socket may be provided on the shell 16. Furthermore, a rocker switch cooperating with the power module 18 may be provided to control power-on or power-off. In addition, button switches indicating designated functions may be further provided on the shell 16, and the button switches are connected to the controlling module 17 to achieve those designated functions, such as a start button, an end button, a preheating button, a heating button, an excitation light button and the like, to cooperate with a user for use.

Specifically, for button switches, a control method for a portable nucleic acid detection device based on button switches is provided: in a case of first use, control instructions corresponding to each button switch are stored in the controlling module 17, and the control instructions related to the button switches can be triggered by clicking the button switches. Specifically, for example, a first operating parameter may be stored for the start button, and the portable nucleic acid detection device may be controlled to detect the reaction tube 2 according to the first operating parameter. The first operating parameter is pre-stored by the staff. Furthermore, after a mobile device carries out a complete nucleic acid detection on the portable nucleic acid detection device, the controlling module 17 can store the current detection parameter as a second operating parameter. Afterwards, if nucleic acid detection operation is triggered by the button switch, the second operating parameter in a memory is read to instruct the portable nucleic acid detection device to carry out the nucleic acid detection. Specifically, the first operating parameter and the second operating parameter may include a time parameter, a temperature parameter, a static parameter, and the like. As such, the portable nucleic acid detection device can carry out detection in the presence or absence of a mobile network, to adapt to most work environments, thereby improving portability.

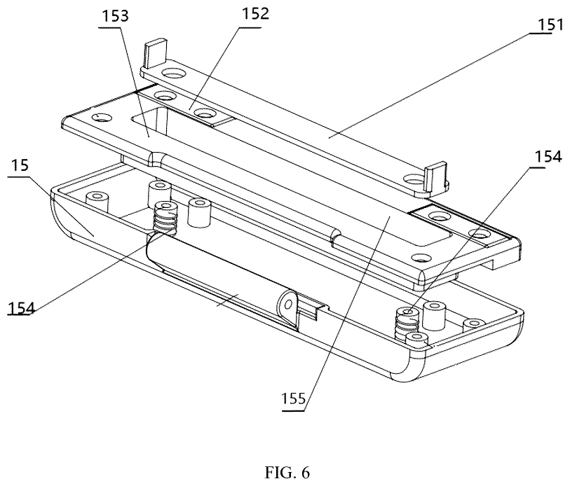

FIG. 6 illustrates a sixth structural diagram of the portable nucleic acid detection device according to an embodiment of the present disclosure. Refer to FIG. 6.

In one possible implementation, the main body 1 includes a cover 15 and a shell 16, the cover 15 is rotatably connected to the shell 16, and the shell 16 is configured to abut against the bearing module 11. The cover 15 includes a pressure plate 151, and the pressure plate 151 is elastically connected to the cover 15 through an elastic member 154; when the cover 15 covers the shell 16, the pressure plate 151 is configured to press the reaction tube 2 in the bearing module 11.

In the embodiments of the present disclosure, the main body 1 includes the cover 15 and the shell 16, which may be connected by hinges; the cover 15 includes the pressure plate 151, the pressure plate 151 is C-shaped, a back abuts against the cover 15, and C-shaped ends are attached to the bearing module 11, such that the heat of the heating module 12 is conducted by the C-shaped ends, which can prevent condensation above the cover 15 in the reaction process. The pressure plate 151 is elastically connected to the cover 15 through the elastic member 154. Specifically, the elastic member 154 may be a spring connected to the cover 15 through a guide shaft. When the cover 15 covers the shell 16, the C-shaped ends of the pressure plate 151 abut against the bearing module 11 to press the reaction tube 2. The cover 15 is provided with a magnetic switch 152, and the magnetic switch 152 is configured to cooperate with the shell 16 to open or close the cover 15. The magnetic switch 152 may be implemented by two magnetic members or by a magnetic member and a metal part that cooperate with each other. Specifically, a cover mounting plate 153 may be provided on the cover 15, and a pressure plate groove 155 for connecting the pressure plate 151 is formed on the cover mounting plate 153. Specifically, as shown in FIG. 3, the shell 16 may further include: mounting plate mounting columns 161 for cooperating with the mounting plate 114 of the bearing module 11 for fixing; and button mounting columns 162 for mounting and fixing button switches.

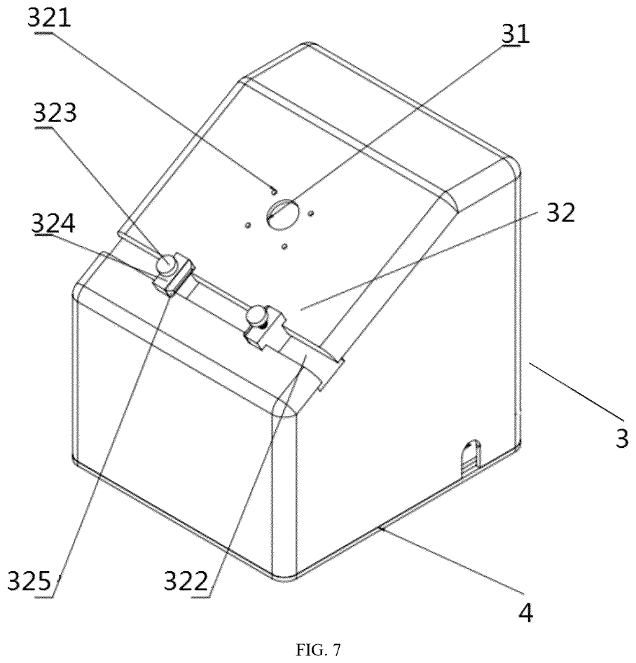

FIG. 7 illustrates a seventh structural diagram of the portable nucleic acid detection device according to an embodiment of the present disclosure. Refer to FIG. 7.

In one possible implementation, the portable nucleic acid detection device further includes a darkroom shell 3, and the darkroom shell 3 may be configured to mount a mobile device or a camera. The darkroom shell 3 is provided with a second observation hole 31, and the second observation hole 31 is configured to cooperate with the mobile device or the camera to observe the reaction tube 2. The darkroom shell 3 is provided with a fixing mechanism 32, and the fixing mechanism 32 is configured to fix the mobile device, such that the mobile device observes the reaction tube 2 via the second observation hole 31.

In the embodiments of the present disclosure, photography requires a relatively dark environment, which prevents the reflection of the filter from affecting the photography effect to affect the detection result. If real-time quantitative detection/testing is to be completed, the mobile device or the camera is required for real-time photography and processing. Therefore, a packaging box of the portable nucleic acid detection device is designed as the darkroom structure, which is suitable for the mobile device or the camera to take pictures. The packaging box may be the darkroom shell 3 in this embodiment, or other shaped shells with the same function/effect as the darkroom shell 3, which is not specifically limited here. Accordingly, the darkroom shell 3 is provided with a darkroom that can be used to load the camera or the mobile device for photography. The darkroom shell 3 is connected to a bottom plate 4. The bottom plate 4 has a mounting groove for positioning and mounting the portable nucleic acid detection device, and a mounting step/stair coordinated with the darkroom shell 3. As shown in FIG. 7, the portable nucleic acid detection device and the darkroom shell 3 are mounted on the bottom plate 4 respectively, and the portable nucleic acid detection device is disposed inside the darkroom shell 3. The shell 16 is arranged on a surface of the second observation hole 31. Specifically, the observation window 14 on the shell 16 of the main body 1 matches the position of the second observation hole 31 of the darkroom shell 3, such that the reaction tube 2 can be observed by the camera or the mobile device via the second observation hole 31, the observation window 14, and the first observation hole 112. The fixing mechanism 32 for fixing the mobile device may be connected to the darkroom shell 3. The fixing mechanism 32 includes a first mechanism for mounting the camera. Specifically, the first mechanism is a camera mounting hole 321. Alternatively, the fixing mechanism includes a second mechanism for mounting the mobile device. Specifically, the second mechanism includes a slide rail 322, a fixing screw 323, a slider 324, and a rubber pad 325. The slider 324 is arranged inside the slide rail 322 and is movable along the slide rail 322, one end of the slider 324 is connected to the fixing screw 323, and the fixing screw 323 is configured to fasten the slider 324 to the slide rail 322, so as to tighten the mobile device by the slider 324. The rubber pad 325 is provided on the side of the slider 324 facing the mobile device, and the rubber pad 325 is configured to prevent the mobile device from being scratched. The mobile device is connected to the portable nucleic acid detection device by communication, and specifically, connected to the controlling module 17, so as to control the portable nucleic acid detection device, which includes: regulating heating time and heating temperature; and obtaining real-time temperature information, reaction time information and detection results. Specifically, the controlling module 17 is connected to the mobile device for receiving control instructions from the mobile device, so as to control the heating module 12 to regulate the temperature of the bearing module 11 through the control instructions, or to control the light-emitting module 13 to emit the light through the control instructions.

A specific embodiment is provided. Firstly, the to-be-detected sample 21 (specifically a detection sample) and a matching reagent are added into the reaction tube 2, with a maximum detection capacity of eight channels at a time. The reaction tube 2 containing the sample is put into the bearing module 11 and covered by the cover 15. The cover 15 and the shell 16 are connected at one end by hinges, and opened and closed at the other end by the magnetic switch 152. After the cover 15 is closed, the pressure plate 151 of the cover 15, subjected to compressive elastic force of the elastic member 154, presses the reaction tube 2, thereby avoiding leakage caused by forced opening of a top opening of the reaction tube 2 due to the heating expansion of gas in the reaction tube 2 during reaction. The pressure plate 151 is closely attached to the bearing module 11, which can conduct the heat of the bearing module 11 to the pressure plate 151 to achieve a better temperature control effect. The controlling module 17 is divided into two parts, one is the heating module 12, and the other is the light-emitting module 13. The heating module 12 is controlled by a heating button switch, and the heating module 12 carries out heating according to the temperature and time flow set for the reaction. The light-emitting module 13 is controlled to start and stop by an excitation light button switch, making it convenient to observe the reaction at any time. After the reaction is completed, the light-emitting module 13 is turned on, and the result can be observed with naked eyes, or automatically recognized from a photo captured by the mobile device, or recognized by an integrated camera (such as an OpenMV camera). The mobile device is connected to the portable nucleic acid detection device in a wireless manner, can control heating and excitation light switches, and can modify heating parameters such as heating time, heating temperature and the like of a heating program to apply to isothermal amplification reactions at different temperatures.

Specifically, the present disclosure provides the following two specific application scenarios.

### Application Scenario 1 Alcohol Tolerance Detection

Human alcohol tolerance is divided into three levels: homozygous wild-type alcohol tolerance, heterozygous mutant slight alcohol tolerance, and homozygous mutant alcohol intolerance. When alcohol tolerance is tested, two different reaction systems need to be prepared for one sample, and primers are designed separately for wild and mutant types. If only the wild-type primer reaction system shows amplification, it indicates homozygous wild-type; if only the mutant primer reaction system shows amplification, it indicates homozygous mutant; if the two reaction systems both show amplification, it indicates heterozygous mutant.

Alcohol tolerance detection includes the following steps.
1, enter information of a to-be-tested person.
2, sampling: use a sampling swab to wipe oral epithelial cells as a sample.
3, preparation and preheating of a crude reaction extract: immerse the collected detection sample swab into a nucleic acid release (lysis) reagent, and stand the detection sample swab for 3-5 minutes to obtain a crude nucleic acid extract.
4, plug the portable nucleic acid detection device into a power source and turn on a power switch to preheat the device.
5, reaction preparation and loading: drop the crude nucleic acid extract into the reaction tube 2 containing a nucleic acid amplification freeze-drying reagent, which includes primers, an enzyme and other reactants; shake to completely dissolve and mix the freeze-drying reagent, and put the loaded reaction tube 2 into the bearing module 11.
6, carry out reaction at a preset temperature of 63° C. and a preset time of 30 minutes; press the heating button of the portable nucleic acid detection device again to complete isothermal nucleic acid amplification according to the preset temperature and preset time.
7, result detection: press the excitation light button and directly observe results. If only the wild-type primer reaction system produces fluorescent signals, it indicates homozygous wild-type; if only the mutant primer reaction system produces fluorescent signals, it indicates homozygous mutant; if the two reaction systems both produce fluorescent signals, it indicates heterozygous mutant. The results can alternatively be collected by the mobile camera or integrated camera. Of course, real-time quantitative amplification detection can also be implemented.

### Application scenario 2 Novel coronavirus (SARS-COV-2) detection

SARS-COV-2 is an enveloped positive strand RNA virus, belongs to a β coronavirus genus, and caused the global pandemic of coronavirus disease (COVID-19) in 2019. Its efficient and rapid detection is of great significance for early discovery and prevention of virus transmission. In this example, amplification primers are designed for SARS-COV-2 ORF1ab and N gene conserved sequences, respectively, wihch can rapid screening of SARS-COV-2 and its mutant strains.

SARS-COV-2 detection includes the following steps.
1, entering information of a to-be-tested person.
2, sampling: use a sampling swab to collect a nasal/pharyngeal swab as a sample.
3, preparation of a crude reaction extract: immerse the collected detection sample swab into a nucleic acid release (lysis) reagent, and stand the detection sample swab for 3-5 minutes to obtain a crude nucleic acid extract.
4, preheating: when the crude reaction extract is prepared, plug the portable nucleic acid detection device into a power source and turn on a power switch to preheat the device.
5, reaction preparation and loading: drop the crude nucleic acid extract into the reaction tube 2 containing a nucleic acid amplification freeze-drying reagent, which includes primers, an enzyme and other reactants; shake to completely dissolve and mix the freeze-drying reagent, and put the loaded reaction tube 2 into the bearing module 11.
6, carry out reaction at a preset temperature of 63° C. and a preset time of 30 minutes; press the heating button of the portable nucleic acid detection device again to complete isothermal nucleic acid amplification according to the preset temperature and preset time.
7, result detection: press the excitation light button and directly observe results. If the reaction system produces fluorescent signals, it indicates SARS-COV-2 positive; otherwise, it indicates negative. The results can alternatively be collected by the mobile camera or integrated camera. Of course, real-time quantitative amplification detection can also be implemented.

According to a second aspect of the present disclosure, a portable nucleic acid detection system is provided. The system includes: a mobile device and the portable nucleic acid detection device according to the embodiments of the present disclosure. The mobile device is connected to the portable nucleic acid detection device by communication, and cooperates with the portable nucleic acid detection device for a detection operation.

According to a third aspect of the present disclosure, a nucleic acid detection method is provided. The method includes: placing a reaction tube 2 containing a to-be-detected sample 21 into a bearing module 11; mounting the bearing module 11 into a mounting cavity; according to detection instructions from a mobile device, controlling a heating module 12 to heat the bearing module 11 to a specified temperature, such that the reaction tube 2 is at the specified temperature; according to the detection instructions from the mobile device, controlling a light-emitting module 13 to emit light, such that the emitted light irradiates the reaction tube 2 via a light-transmission hole 111; observing the reaction tube 2 via an observation window 14 on a main body 1 and a first observation hole 112 on the bearing module 11, and determining a detection result based on a fluorescence reaction in the reaction tube 2 under irradiation of the emitted light. Alternatively, nucleic acid detection may be implemented without using the light-emitting module, but by chemiluminescence, colorimetric reaction, and the like, or using a white light-emitting module and colorimetric reaction. Therefore, the present disclosure can be applied to various usage scenarios, thereby greatly improving the scope of use of the portable nucleic acid detection device.

The mobile device is connected to the portable nucleic acid detection device by communication, and specifically, connected to the controlling module 17.

The mobile device sends control instructions to the portable nucleic acid detection device, or receives feedback information from the portable nucleic acid detection device. Specifically, the control instructions may include: regulating heating time and regulating heating temperature. The obtained feedback information may include: real-time temperature information, reaction time information, and detection results for the user to observe at any time, so as to achieve a non-contact detection mode and reduce the risk of infection that may occur in the detection process.

The present disclosure provides a specific embodiment. The present disclosure provides a nucleic acid amplification detection and analysis method, including the following steps:
S1, enter information of a to-be-tested person. Specifically, the information of the to-be-tested person may be manually entered through a program of the mobile device, or entered by scanning health code through the program of the mobile device.
S2, nucleic acid sampling: use a nucleic acid sampling swab for sampling.
S3, preparation of a crude reaction extract: immerse the collected detection sample swab into a nucleic acid release (lysis) reagent to obtain a crude nucleic acid extract.
S4, plug the portable nucleic acid detection device into a power source and turn on a power switch to preheat the device.
S5, reaction preparation and loading: drop the crude nucleic acid extract into the reaction tube 2 containing a nucleic acid amplification freeze-drying reagent; shake to completely dissolve and mix the freeze-drying reagent, and put the loaded reaction tube 2 into the bearing module 11.
S6, detection reaction; press the heating button of the portable nucleic acid detection device to complete rapid isothermal nucleic acid amplification according to the preset temperature and preset time.
S7, obtain a result detection: detect the result of the portable nucleic acid detection device by any one of the following three methods: A, B, or C.
A, the detection personnel directly observe via the observation port of the observation window whether the reaction tube 2 shows a fluorescence signal, so as to qualitatively obtain the detection result.
B, based on developed software of the mobile terminal, capture an image by using a camera of the mobile terminal, store the image, and then process the image to obtain the detection result. This method can achieve endpoint detection, and can also draw a real-time amplification curve on a screen of the mobile device to complete the real-time detection after the real-time sampling is completed at time intervals according to the set program.
C, capture an image with an integrated camera such as an OpenMV camera, and process the image. This method can achieve endpoint detection, and can also send data to the mobile device through a wireless module and draw a real-time amplification curve to complete the real-time detection after the real-time sampling is completed at time intervals according to the set program.
S8, result storing and sharing: enter the result by any one of the following two methods D or E corresponding to the above two detection methods;
D, in responding to that the detection personnel directly observe the reaction tube 2 via the observation port of the observation window to qualitatively obtain the detection result, manually fill the detection result corresponding to the information of the tested person and store the detection information.
E, in responding to obtaining the detection result by image processing, match the specific reaction tube 2 with the information of the tested person and store the detection information.

When the result is stored, the software of the mobile device automatically stores the geographical location of the current detection point and associates the detection result with the geographical location on the map, such that the corresponding detection result can be viewed by clicking on the corresponding detection point on the map.

It should be understood that the steps may be reordered, added or deleted by using the flows in various forms, which are shown above. For example, the steps recorded in the present disclosure may be performed concurrently, in order, or in a different order, provided that the desired result of the technical solutions disclosed in the present disclosure can be achieved, which is not limited herein.

In addition, the terms “first” and “second” are merely used for description purposes and cannot be interpreted as indicating or implying relative importance or implicitly indicating the number of technical features indicated. Therefore, the features defined with “first” and “second” can explicitly or implicitly include one or more features. In the description of the present disclosure, “a plurality of” means two or more than two, unless otherwise specified.

The above are merely specific implementations of the present disclosure, but the scope of protection of the present disclosure is not limited thereto, and any changes or replacements easily conceivable by those skilled in the art within the scope of the technology disclosed herein shall be covered within the scope of protection of the present disclosure. Therefore, the protection scope of the present disclosure shall be subject to the protection scope of the claims.

What is claimed is:

1. A portable nucleic acid detection device, comprising a main body; wherein
the main body is provided with a mounting cavity for mounting a bearing module, the bearing module is configured to accommodate a reaction tube, and the reaction tube is configured to accommodate a to-be-detected sample;
the bearing module is connected to a heating module, and the heating module is configured to regulate a temperature of the bearing module, so as to regulate a temperature of the reaction tube;
the main body is connected to a light-emitting module, the light-emitting module is arranged at a bottom of the bearing module, and the bearing module is provided with a light-transmission hole facing the light-emitting module, such that light emitted from the light-emitting module irradiates the reaction tube via the light-transmission hole; and
the main body is further provided with an observation window, a first side of the bearing module is provided with a first observation hole, and the first observation hole is configured to observe the reaction tube, when the bearing module is mounted in the mounting cavity, the observation window is configured to observe the reaction tube via the first observation hole.

2. The portable nucleic acid detection device according to claim 1, wherein the bearing module is provided with a plurality of grooves, and the groove is configured to accommodate the reaction tube;
a quantity of the light-transmission hole is consistent with a quantity of the groove the light-transmission hole is arranged at a bottom of the groove, and the light-emitting module is securely connected to the bottom of the bearing module, such that the light emitted from the light-emitting module irradiates the reaction tube via the light-transmission hole; and
the bearing module further comprises a mounting plate, and the mounting plate is configured to cooperate with the main body to fix the bearing module in the mounting cavity.

3. The portable nucleic acid detection device according to claim 1, wherein
the heating module is connected to a second side of the bearing module, wherein the second side is different from the first side;
the heating module comprises a heating element, a temperature sensor, and an overheat protection module; the temperature sensor is arranged between the heating element and the bearing module, the heating module is configured to regulate the temperature of the bearing module, and the temperature sensor is configured to detect the temperature of the bearing module; and
the temperature sensor is connected to the overheat protection module, and the overheat protection module is connected to the heating element; when a temperature detected by the temperature sensor is higher than a specified temperature, the overheat protection module is configured to allow the heating element to stop heating.

4. The portable nucleic acid detection device according to claim 3, wherein
the temperature sensor comprises at least one of a thermistor, a platinum resistor, or a thermocouple; and the heating element comprises at least one of a ceramic heating element, an electric heating film, an electric heating wire, a power resistor, or a semiconductor heating element.

5. The portable nucleic acid detection device according to claim 1, wherein
the main body comprises a cover and a shell, the cover is rotatably connected to the shell, and the shell is configured to abut against the bearing module; the cover comprises a pressure plate, and the pressure plate is elastically connected to the cover by an elastic member; when the cover covers the shell, pressure plate is configured to press the reaction tube in the bearing module.

6. The portable nucleic acid detection device according to claim 5, wherein the cover is provided with a magnetic switch, and the magnetic switch is configured to cooperate with the shell to open or close the cover.

7. The portable nucleic acid detection device according to claim 1, wherein the portable nucleic acid detection device is provided with a controlling module, and the controlling module is connected to the heating module for controlling the heating module to regulate the temperature of the bearing module;
the controlling module is further connected to the light-emitting module for controlling the light-emitting module to emit the light to irradiate the reaction tube; and
the controlling module is connected to a mobile device for receiving control instructions from the mobile device, so as to control the heating module to regulate the temperature of the bearing module through the control instructions, or to control the light-emitting module to emit the light through the control instructions.

8. The portable nucleic acid detection device according to claim 1, further comprising a darkroom shell, wherein the darkroom shell is configured to mount a mobile device or a camera; and
the darkroom shell is provided with a second observation hole, and the second observation hole is configured to cooperate with the mobile device or the camera to observe the reaction tube.

9. The portable nucleic acid detection device according to claim 8, wherein the darkroom shell is provided with a fixing mechanism, and the fixing mechanism is configured to fix the mobile device, such that the mobile device observes the reaction tube via the second observation hole.

10. The portable nucleic acid detection device according to claim 1, wherein a filter is mounted on an observation port of the observation window.

11. A portable nucleic acid detection system, comprising a mobile device and the portable nucleic acid detection device according to claim 1, wherein the mobile device is connected to the portable nucleic acid detection device by communication, and cooperates with the portable nucleic acid detection device for a detection operation.

12. A nucleic acid detection method, comprising:
placing a reaction tube containing a to-be-detected sample into a bearing module-mounting;
mounting the bearing module into a mounting cavity;
according to detection instructions from a mobile device, controlling a heating module to heat the bearing module to a specified temperature, such that the reaction tube is at the specified temperature;
according to the detection instructions from the mobile device, controlling a light-emitting module to emit light, such that the light irradiates the reaction tube via a light-transmission hole; and
observing the reaction tube via an observation window on a main body and a first observation hole on the bearing module, and determining a detection result based on a fluorescence reaction in the reaction tube under irradiation of the light.
